(19) United States
(12) Patent Application Publication
(10) Pub. No.: US 2022/0181985 A1
(43) Pub. Date: Jun. 9, 2022

(54) POWER CONVERSION SYSTEM, AND DIAGNOSIS METHOD AND PROGRAM FOR POWER CONVERSION CIRCUIT

(71) Applicant: Panasonic Intellectual Property Management Co., Ltd., Osaka (JP)

(72) Inventors: Kenichi ASANUMA, Osaka (JP); Fumito KUSAMA, Kanagawa (JP)

(21) Appl. No.: 17/440,685

(22) PCT Filed: Mar. 5, 2020
(86) PCT No.: PCT/JP2020/009322

§ 371 Date: Sep. 17, 2021

(30) Foreign Application Priority Data
Mar. 20, 2019 (JP) 2019-053844

(51) Int. Cl. H02M 3/335; H02M 1/34; H02M 7/48

(52) U.S. Cl. CPC H02M 3/33584; H02M 7/4807; H02M 1/34

(57) ABSTRACT

A power conversion system configured to determine whether or not an abnormality is present in a power conversion circuit, and diagnosis method and program for the power conversion circuit are provided. A power conversion system includes a power conversion circuit, a snubber circuit, and a diagnosis unit. The power conversion circuit includes a transformer and a switching element configured to be electrically connected to the transformer, and the power conversion circuit is configured to convert electric power. The snubber circuit is electrically connected to the transformer and is configured to extract electrical energy from the power conversion circuit. The diagnosis unit is configured to make diagnosis for the power conversion circuit in accordance with at least one of a voltage at a terminal of the transformer, a voltage generated at the snubber circuit, or a current generated at the snubber circuit.

### TECHNICAL FIELD

The present disclosure relates generally to power conversion systems, and diagnosis methods and programs for the power conversion circuits, and specifically, to a power conversion system including a power conversion circuit configured to convert electric power, and a diagnosis method and a program for the power conversion circuit.

### BACKGROUND ART

An alternating current/direct current electric power converter (a power conversion system) including a snubber circuit has been known (see, for example, Patent Literature 1).

The alternating current/direct current electric power converter of Patent Literature 1 includes a three-phase rectifier, an inverter, a high frequency transformer, a load-side rectifier (a power conversion circuit), and a snubber circuit. The three-phase rectifier is configured to receive a sine wave three-phase alternating current and convert the sine wave three-phase alternating current into a high frequency pulsating current having a positive voltage. The inverter is configured to convert the high frequency pulsating current into a single-phase alternating current of rectangular wave. The high frequency transformer is configured to insulate and convert the voltage of the single-phase alternating current. The snubber circuit is connected between the three-phase rectifier and the inverter and the inverter and is configured to extract and regenerate energy resulting from leakage inductance of the high frequency transformer. The load-side rectifier is configured to convert the single-phase alternating current, whose voltage has been insulated and converted by the high frequency transformer, into a direct current.

If the power conversion system has an abnormality in the power conversion circuit, such an abnormality may decrease the power conversion efficiency of the power conversion circuit, and therefore, it is desirable to detect the abnormality in the power conversion circuit.

### CITATION LIST

### Patent Literature

Patent Literature 1: JP 2013-158064 A

### SUMMARY OF INVENTION

In view of the foregoing, it is an object of the present invention to provide a power conversion system configured to determine whether or not an abnormality is present in a power conversion circuit, and diagnosis method and a program for the power conversion circuit.

A power conversion system according to an aspect of the present disclosure includes a power conversion circuit, a snubber circuit, and a diagnosis unit. The power conversion circuit includes a transformer and a switching element configured to be electrically connected to the transformer, and the power conversion circuit is configured to convert electric power. The snubber circuit is configured to be electrically connected to the transformer and extract electrical energy from the power conversion circuit. The diagnosis unit is configured to make diagnosis for the power conversion circuit in accordance with at least one of a voltage at a terminal of the transformer, a voltage generated at the snubber circuit, or a current generated at the snubber circuit.

A diagnosis method for a power conversion circuit according to an aspect of the present disclosure is a diagnosis method for a power conversion circuit including a transformer and a switching element configured to be electrically connected to the transformer, the power conversion circuit being configured to convert electric power, and the diagnosis method includes a diagnosis process. The diagnosis process includes making diagnosis for the power conversion circuit in accordance with at least one of a voltage at a terminal of the transformer, a voltage generated at a snubber circuit, or a current generated at the snubber circuit, the snubber circuit being configured to be electrically connected to the transformer and extract electrical energy from the power conversion circuit.

A program according to an aspect of the present disclosure is configured to cause a computer system to execute the diagnosis method for the power conversion circuit.

### BRIEF DESCRIPTION OF DRAWINGS

FIG. 1 is a circuit diagram illustrating a power conversion system of an embodiment of the present disclosure;

FIG. 2 is an operation waveform diagram in the case where a power conversion circuit is in a normal state in the power conversion system;

FIG. 3 is an operation waveform diagram in the case where a power conversion circuit is in an abnormal state in the power conversion system;

FIG. 4 is an operation waveform diagram in the case where a power conversion circuit is in another abnormal state in the power conversion system;

FIG. 5 is a graph illustrating a determination range in the power conversion system;

FIG. 6 is an operation flowchart of the power conversion system; and

FIGS. 7A and 7B are block diagrams illustrating variations of the power conversion system.

### DESCRIPTION OF EMBODIMENTS

An embodiment and variations described below are mere examples of the present disclosure, and the present disclosure is not limited to the embodiment and the variations. Various modifications may be made without departing from the scope of technical idea of the present disclosure, even if not including the embodiments and the variations, according to design or the like.

### Embodiment

(1) Schema

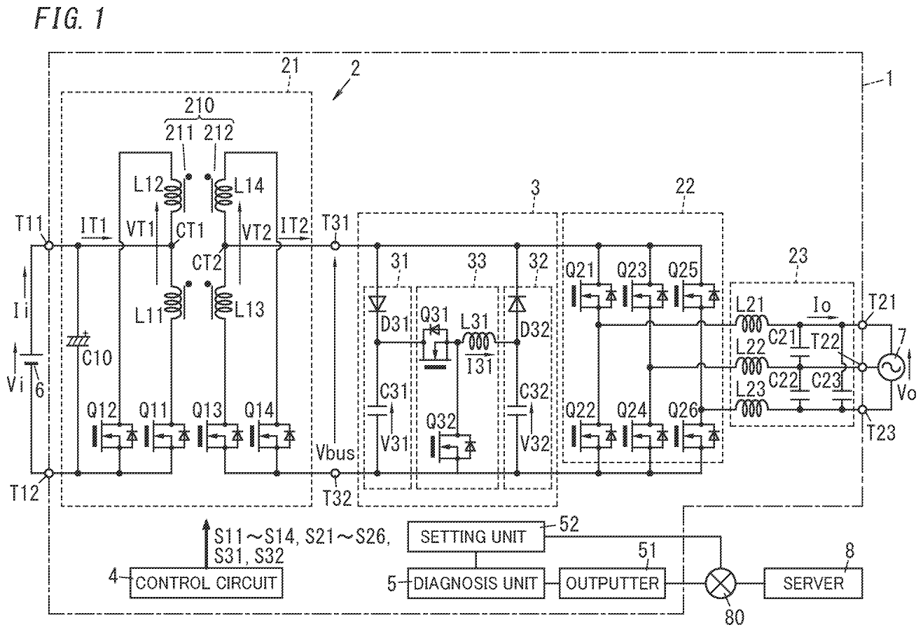

First of all, a schema of a power conversion system 1 according to the present embodiment will be described with reference to FIG. 1.

As illustrated in FIG. 1, the power conversion system 1 according to the present embodiment is a system configured to perform electric power conversion between a set of direct current terminals T11 and T12 and a set of alternating current terminals T21, T22, and T23. To the direct current terminals T11 and T12, a storage battery 6 is configured to be electrically connected. To the alternating current terminals T21, T22, and T23, a power system 7 is configured to be electrically connected. As used herein, the “power system 7” means an entire system based on which an electricity supplier such as an electric power company supplies electric power to a power receiving facility of a consumer.

The power conversion system 1 according to the present embodiment converts direct current power input from the storage battery 6 into alternating current power having three phases, namely, a U phase, a V phase, and a W phase, and outputs (transmits) the alternating current power to the power system 7. Moreover, the power conversion system 1 converts alternating current power having three phases, namely, a U phase, a V phase, and a W phase input from the power system 7 into direct current power, and outputs the direct current power to the storage battery 6. That is, the power conversion system 1 bidirectionally performs electric power conversion between a set of direct current terminals T11 and T12 and a set of alternating current terminals T21, T22, and T23.

In other words, to discharge the storage battery 6, the power conversion system 1 converts the direct current power input from the storage battery 6 into the alternating current power and outputs (discharges) the alternating current power to the power system 7. At this time, the storage battery 6 functions as a “direct current power supply”, and the power system 7 functions as a “three-phase alternating current load” having a U phase, a V phase, and a W phase. Moreover, to charge the storage battery 6, the power conversion system 1 converts the alternating current power input from the power system 7 into the direct current power and outputs the direct current power to the storage battery 6 (charges the storage battery 6 with the direct current power). In this state, the storage battery 6 functions as a “direct current load”, and the power system 7 functions as a “three-phase alternating current power supply” having a U phase, a V phase and a W phase.

The power conversion system 1 of the present embodiment includes a power conversion circuit 2, a snubber circuit 3, a control circuit 4, and a diagnosis unit 5.

The power conversion circuit 2 bidirectionally performs electric power conversion between a set of direct current terminals T11 and T12 and a set of alternating current terminals T21, T22, and T23. The snubber circuit 3 is a protection circuit configured to control ringing or a surge voltage generated at the power conversion circuit 2. When the power conversion circuit 2 converts, for example, direct current power into alternating current power or the alternating current power into the direct current power, ringing may occur due to leakage inductance of a transformer 210 included in the power conversion circuit 2. The power conversion system 1 enables such ringing to be suppressed by the snubber circuit 3. The diagnosis unit 5 makes diagnosis for the power conversion circuit 2 in accordance with at least one of a voltage at a terminal of the transformer 210, a voltage generated at the snubber circuit 3, or a current generated at the snubber circuit 3.

In the present embodiment, for example, a description is given of a case where a power storage system including the power conversion system 1 and the storage battery 6 is introduced into a non-dwelling facility such as an office building, a hospital, a commercial facility, or a school.

“Electric power selling” is particularly recently widespread. The “electric power selling” refers to a reverse power flow of electric power, which a juridical person or a person has obtained from a distributed power supply (e.g., a photovoltaic cell, the storage battery 6, or a fuel cell), to the power system 7. The electric power selling is achieved by system interconnection that connects the distributed power supply to the power system 7. In the system interconnection, the power conversion system 1 referred to as a power conditioner is used to convert electric power of the distributed power supply into electric power adapted to the power system 7. The power conversion system 1 according to the present embodiment is used as, for example, a power conditioner, and the direct current power is converted into three-phase alternating current power and vice versa between the storage battery 6 as the distributed power supply and the power system 7.

(2) Configuration

Components included in the power conversion system 1 will be described in detail with reference to FIG. 1.

(2.1) Power Conversion Circuit

The power conversion circuit 2 performs electric power conversion between the set of two direct current terminals T11 and T12 and the set of three alternating current terminals T21, T22, and T23.

To the direct current terminals T11 and T12, the storage battery 6, which functions as the direct current power supply or a direct current load, is configured to be electrically connected. In the present embodiment, the storage battery 6 is electrically connected between the direct current terminals T11 and T12 such that of the two direct current terminals T11 and T12, the direct current terminal T11 has a relatively high potential (serves as a positive electrode) and the direct current terminal T12 has a relatively low potential (serves as a negative electrode).

To the alternating current terminals T21, T22, and T23, the power system 7, which functions as a three-phase alternating current power supply or a three-phase alternating current load having the U phase, the V phase, and the W phase, is configured to be electrically connected. The alternating current terminal T21 is connected to the U phase, the alternating current terminal T22 is connected to the V phase, and the alternating current terminal T23 is connected to the W phase.

The power conversion circuit 2 includes a first conversion circuit 21, a second conversion circuit 22, and a filter circuit 23. The power conversion circuit 2 further includes the two direct current terminals T11 and T12 and the three alternating current terminals T21, T22, and T23. Note that the two direct current terminals T11 and T12 and the three alternating current terminals T21, T22, and T23 do not have to be included in the power conversion circuit 2. Moreover, the “terminal” as mentioned herein does not have to be a component for connecting an electric wire and the like but may be, for example, a lead of an electronic component or part of a conductor included in a circuit board.

The first conversion circuit 21 is, for example, a DC/DC converter. As illustrated in FIG. 1, the first conversion circuit 21 includes a capacitor C10, the transformer 210, and switching elements Q11 to Q14.

The capacitor C10 is electrically connected between the two direct current terminals T11 and T12. In other words, the capacitor C10 is connected via the two direct current terminals T11 and T12 to the storage battery 6. The capacitor C10 is, for example, an electrolytic capacitor. The capacitor C10 has a function of stabilizing a voltage between the direct current terminals T11 and T12. The capacitor C10 does not have to be included in components of the first conversion circuit 21.

Each of the switching elements Q11 to Q14 is, for example, an n-channel depletion metal-oxide-semiconductor field effect transistor (MOSFET). Each of the switching elements Q11 to Q14 includes a parasitic diode. The parasitic diodes of the switching elements Q11 to Q14 have: anodes electrically connected respectively to the sources of the switching elements Q11 to Q14; and cathodes electrically connected respectively to the drains of the switching elements Q11 to Q14.

Each of the switching elements Q11 to Q14 is controlled by the control circuit 4.

The transformer 210 includes a primary winding wire 211 and a secondary winding wire 212 which are magnetically connected to each other. The primary winding wire 211 is electrically connected via the switching elements Q11 and Q12 to the capacitor C10. The secondary winding wire 212 is electrically connected via the switching elements Q13 and Q14 to the snubber circuit 3.

The transformer 210 is, for example, a high-frequency insulated transformer equipped with a center tap. The primary winding wire 211 of the transformer 210 includes a series circuit of two winding wires L11 and L12 with a primary-side center tap CT1 as a connection point. Similarly, the secondary winding wire 212 of the transformer 210 includes a series circuit of two winding wires L13 and L14 with a secondary-side center tap CT2 as a connection point. That is, the two winding wires L11 and L12 are electrically connected in series to each other to form the primary winding wire 211. Similarly, the two winding wires L13 and L14 are electrically connected in series to each other to form the secondary winding wire 212. The primary-side center tap CT1 is electrically connected to a terminal of the capacitor C10. on the positive side (at the side of the direct current terminal T11). The secondary-side center tap CT2 is electrically connected to a terminal T31 which will be described later. The turns ratio of the winding wires L11, L12, L13, and L14 is, for example, 1:1:1:1. The turns ratio of the winding wires L11, L12, L13, and L14 is arbitrarily changeable in accordance with a specification or the like of the power conversion system 1.

To the first conversion circuit 21, a voltage across the storage battery 6 is applied as an input voltage Vi via the direct current terminals T11 and T12.

In the first conversion circuit 21, turning ON/OFF of the switching elements Q11 and Q12 converts the input voltage Vi into a square wave high-frequency alternating current voltage at, for example, 20 kHz and applies the square wave high-frequency alternating current voltage to the primary winding wire 211 (the winding wires L11 and L12).

The switching element Q11 is electrically connected in series to the winding wire L11 between both ends of the capacitor C10. The switching element Q12 is electrically connected in series to the winding wire L12 between both ends of the capacitor C10. In other words, between the direct current terminals T11 and T12, a series circuit of the switching element Q11 and the winding wire L11 is electrically connected in parallel to a series circuit of the switching element Q12 and the winding wire L12.

The switching element Q11 has a drain electrically connected to the primary-side center tap CT1 via the winding wire L11. The switching element Q12 has a drain electrically connected to the primary-side center tap CT1 via the winding wire L12. The switching elements Q11 and Q12 each have a source electrically connected to the direct current terminal T12 on the low-potential (negative) side.

In the first conversion circuit 21, the switching elements Q13 and Q14 is turned ON/OFF to convert a square wave alternating current voltage generated at the secondary winding wire 212 (the winding wires L13 and L14) and having positive and negative polarities into a direct current voltage having a positive polarity and to output the direct current voltage between the two terminals T31 and T32. In this embodiment, a voltage is supplied between the terminals T31 and T32 such that of the two terminals T31 and T32, the terminal T31 has a relatively high potential (serves as a positive electrode) and the terminal T32 has a relatively low potential (serves as a negative electrode).

The switching element Q13 is electrically connected in series to the winding wire L13 between the terminals T31 and T32. The switching element Q14 is electrically connected in series to the winding wire L14 between the terminals T31 and T32. That is, between the terminals T31 and T32, a series circuit of the switching element Q13 and the winding wire L13 is electrically connected in parallel to a series circuit of the switching element Q14 and the winding wire L14.

The switching element Q13 has a drain electrically connected to the secondary-side center tap CT2 via the winding wire L13. The switching element Q14 has a drain electrically connected to the secondary-side center tap CT2 via the winding wire L14. The switching elements Q13 and Q14 each have a source electrically connected to the terminal T32 on the low-potential (negative) side.

The second conversion circuit 22 is a three-phase inverter circuit configured to convert the direct current voltage between the terminals T31 and T32 into the square wave alternating current voltage and includes a bridge connection of six switching elements Q21 to Q26.

Each of the switching elements Q21 to Q26 is, for example, an n-channel depletion MOSFET. The switching element Q21 on a high-potential side is electrically connected in series to the switching element Q22 on a low-potential side between the terminals T31 and T32. The switching element Q23 on the high-potential side is electrically connected in series to the switching element Q24 on the low-potential side Between the terminals T31 and T32. The switching element Q25 on the high-potential side is electrically connected in series to the switching element Q26 on the low-potential side Between the terminals T31 and T32.

The switching elements Q21, Q23, and Q25 on the high-potential side each have a drain electrically connected to the terminal T31. The switching elements Q22, Q24, and Q26 on the low-potential side each have a source electrically connected to the terminal T32. Moreover, the switching element Q21 on the high-potential side has a source electrically connected to the drain of the switching element Q22 on the low-potential side. The switching element Q23 on the high-potential side has a source electrically connected to the drain of the switching element Q24 on the low-potential side. The switching element Q25 on the high-potential side has a source electrically connected to the drain of the switching element Q26 on the low-potential side.

That is, a series circuit of the switching elements Q21 and Q22, a series circuit of the switching elements Q23 and Q24, and a series circuit of the switching elements Q25 and Q26 are electrically connected in parallel to one another between the terminals T31 and T32. The series circuit of the switching elements Q21 and Q22 forms a U phase circuit corresponding to the U phase. The series circuit of the switching elements Q23 and Q24 forms a V phase circuit corresponding to the V phase. The series circuit of the switching elements Q25 and Q26 forms a W phase circuit corresponding to the W phase.

Each of the switching elements Q21 to Q26 include a parasitic diode. The parasitic diodes of the switching elements Q21 to Q26 have: anodes electrically connected respectively to the sources of the switching elements Q21 to Q26; and cathodes electrically connected respectively to the drains of the switching elements Q21 to Q26.

Each of the switching elements Q21 to Q26 is controlled by the control circuit 4.

The filter circuit 23 smooths the square wave alternating current voltage output from the second conversion circuit 22. Thus, the square wave alternating current voltage output from the second conversion circuit 22 is converted into a sine wave alternating current voltage having an amplitude according to a pulse width.

Specifically, the filter circuit 23 includes a plurality of (in FIG. 1, three) inductors L21, L22, and L23 and a plurality of (in FIG. 1, three) capacitors C21, C22, and C23. The inductor L21 has one end electrically connected to a connection point between the switching elements Q21 and Q22. The inductor L21 has the other end electrically connected to the alternating current terminal T21. The inductor L22 has one end electrically connected to a connection point between the switching elements Q23 and Q24. The inductor L22 has the other end electrically connected to the alternating current terminal T22. The inductor L23 has one end electrically connected a connection point between the switching elements Q25 and Q26. The inductor L23 has the other end electrically connected to the alternating current terminal T23. The capacitor C21 is electrically connected between the alternating current terminals T21 and T22. The capacitor C22 is electrically connected between the alternating current terminals T22 and T23. The capacitor C23 is electrically connected between the alternating current terminals T21 and T23.

In other words, the connection point between the switching elements Q21 and Q22 forming the U phase circuit is electrically connected via the inductor L21 to the alternating current terminal T21 corresponding to the U phase. The connection point between the switching elements Q23 and Q24 forming the V phase circuit is electrically connected via the inductor L22 to the alternating current terminal T22 corresponding to the V phase. The connection point between the switching elements Q25 and Q26 forming the W phase circuit is electrically connected via the inductor L23 to the alternating current terminal T23 corresponding to the W phase.

(2.2) Snubber Circuit

The snubber circuit 3 is electrically connected to the terminals T31 and T32 in the power conversion circuit 2. That is, the snubber circuit 3 is electrically connected via the terminals T31 and T32 to the transformer 210.

The snubber circuit 3 is a regenerative snubber circuit configured to extract electrical energy from the power conversion circuit 2 and inject (regenerate) electrical energy into the power conversion circuit 2. When a bus voltage Vbus between the terminals T31 and T32 exceeds a first clamp value, the snubber circuit 3 extracts electrical energy exceeding the first clamp value from the power conversion circuit 2, thereby clamping an upper limit value of the bus voltage Vbus to the first clamp value. Moreover, when the bus voltage Vbus is less than a second clamp value (<first clamp value), the snubber circuit 3 injects (regenerates) electrical energy into the power conversion circuit 2, thereby clamping a lower limit value of the bus voltage Vbus to the second clamp value.

The snubber circuit 3 includes a first clamp circuit 31, a second clamp circuit 32, and a voltage conversion circuit 33.

The first clamp circuit 31 is a circuit configured to, when the bus voltage Vbus exceeds the first clamp value, extract electrical energy from the power conversion circuit 2. The first clamp circuit 31 includes a diode D31 and a capacitor C31. The diode D31 and the capacitor C31 are electrically connected in series to each other between the terminals T31 and T32. The first clamp circuit 31 is configured to, when the bus voltage Vbus exceeds the first clamp value, allow a current to flow from the power conversion circuit 2 via the diode D31 to the capacitor. Specifically, the diode has an anode electrically connected to the terminal T31 on the high-potential side, and a cathode electrically connected

via the capacitor C31 to the terminal T32 on the low-potential side.

In the first clamp circuit 31, the magnitude of a voltage across the capacitor C31 (also referred to as a first clamp voltage V31) is assumed to be the first clamp value, and in this case, the diode D31 is turned ON when the bus voltage Vbus exceeds the first clamp value, and thereby, a current flows through the capacitor C31. Strictly speaking, the first clamp voltage is a voltage obtained by adding a forward direction drop voltage of the diode D31 to the voltage across the capacitor C31 (the first clamp voltage V31). Note that the forward direction drop voltage of the diode D31 is sufficiently smaller than the first clamp value, and therefore, the present embodiment is described assuming that the forward direction drop voltage of the diode D31 is zero, that is, the magnitude of the voltage across the capacitor C31 (the first clamp voltage V31) corresponds to the first clamp value.

The second clamp circuit 32 is a circuit configured to, when the bus voltage Vbus is less than the second clamp value, inject (regenerate) electrical energy into the power conversion circuit 2. The second clamp circuit 32 includes a diode D32 and a capacitor C32. The diode D32 and the capacitor C32 are electrically connected in series to each other between the terminals T31 and T32. The second clamp circuit 32 is configured to, when the bus voltage Vbus is less than the second clamp value, allow a current to flow from the capacitor C32 via the diode D32 to the power conversion circuit 2. Specifically, the diode D32 has: a cathode electrically connected to the terminal T31 on the high-potential side; and an anode electrically connected via the capacitor C32 to the terminal T32 on the low-potential side.

In the second clamp circuit 32, the magnitude of a voltage across the capacitor C32 (also referred to as a second clamp voltage V32) is assumed to be the second clamp value, and in this case, the diode D32 is turned ON when the bus voltage Vbus is less than the second clamp value, and thereby, a current flows through the power conversion circuit 2. Strictly speaking, the second clamp value is a voltage obtained by adding a forward direction drop voltage of the diode D32 to the voltage across the capacitor C32 (the second clamp voltage V32). Note that the forward direction drop voltage of the diode D32 is sufficiently smaller than the second clamp value, and therefore, the present embodiment is described assuming that the forward direction drop voltage of the diode D32 is zero, that is, the magnitude of the voltage across the capacitor C32 (the second clamp voltage V32) corresponds to the second clamp value.

The voltage conversion circuit 33 is electrically connected to the first clamp circuit 31 and the second clamp circuit 32. The voltage conversion circuit 33 performs voltage conversion (step-down, step-up, or step-up and down) between the first clamp voltage V31 and the second clamp voltage V32.

The voltage conversion circuit 33 is a chopper-type DC/DC converter including switching elements Q31 and Q32 and an inductor L31. In the present embodiment, the voltage conversion circuit 33 is a step-down chopper circuit and steps down the first clamp voltage V31 to generate the second clamp voltage V32. The switching elements Q31 and Q32 are each an n-channel depletion MOSFET.

The switching elements Q31 and Q32 are electrically connected in series between both ends of the capacitor C31. The switching element Q31 has a drain electrically connected to the cathode of the diode D31. The switching element Q32 has a source electrically connected to the terminal (the terminal T32) on the negative side of the capacitor C31.

The inductor L31 is electrically connected to the switching element Q32 between both ends of the capacitor C32. Specifically, the inductor L31 is electrically connected between a connection point of the source of the switching element Q31 and the drain of the switching element Q32 and a connection point of the anode of the diode D32 and the capacitor C32.

(2.3) Control Circuit

The control circuit 4 includes a microcomputer having a processor and memory. That is, the control circuit 4 is implemented by a computer system including a processor and memory. The processor executes an appropriate program, and thereby, the computer system functions as the control circuit 4. The program may be stored in the memory in advance, may be provided via a telecommunications network such as the Internet, or may be provided by a non-transitory storage medium such as a memory card storing the program.

The control circuit 4 is configured to control the first conversion circuit 21 and the second conversion circuit 22 of the power conversion circuit 2 and the voltage conversion circuit 33 of the snubber circuit 3. The control circuit 4 outputs, to the first conversion circuit 21, drive signals S11 to S14 for respectively driving the switching elements Q11 to Q14. The control circuit 4 outputs, to the second conversion circuit 22, drive signals S21 to S26 for respectively driving the switching elements Q21 to Q26. The control circuit 4 outputs, to the voltage conversion circuit 33, drive signals S31 and S32 for respectively driving the switching elements Q31 and Q32. Each of the drive signals S11 to S14, S21 to S26, and S31 and S32 is a PWM signal including a binary signal which is switchable between a high level (an example of an active value) and a low level (an example of a non-active value).

(2.4) Diagnosis Unit

The diagnosis unit 5 includes a microcomputer including a processor and memory. That is, the diagnosis unit 5 is implemented by a computer system including a processor and memory. The processor executes an appropriate program, and thereby, the computer system functions as the diagnosis unit 5. The program may be stored in the memory in advance, may be provided via a telecommunications network such as the Internet, or may be provided by a non-transitory storage medium such as a memory card storing the program.

The diagnosis unit 5 is configured to make diagnosis for the power conversion circuit 2. As used herein, the “diagnosis for the power conversion circuit 2” means that whether or not an abnormality is present in the power conversion circuit 2 is determined.

In this embodiment, when an abnormality is present in the power conversion circuit 2, the voltage of the terminal of the transformer 210 changes. Examples of the abnormality in the power conversion circuit 2 include an increase in leakage inductance of the transformer 210, an increase in excitation inductance due to biased magnetization of the transformer 210, an increase or a decrease in parasitic capacitance of the first conversion circuit 21, and a change in threshold voltage of the switching elements (Q11 to Q14). When such an abnormality is present in the power conversion circuit 2, the voltage of the terminal of the transformer 210 increases. Examples of the voltage of the terminal of the transformer 210 include, for example, a voltage VT2 across the secondary winding wire 212 of the transformer 210, a voltage across the winding wire L13, and a voltage across the winding wire L14.

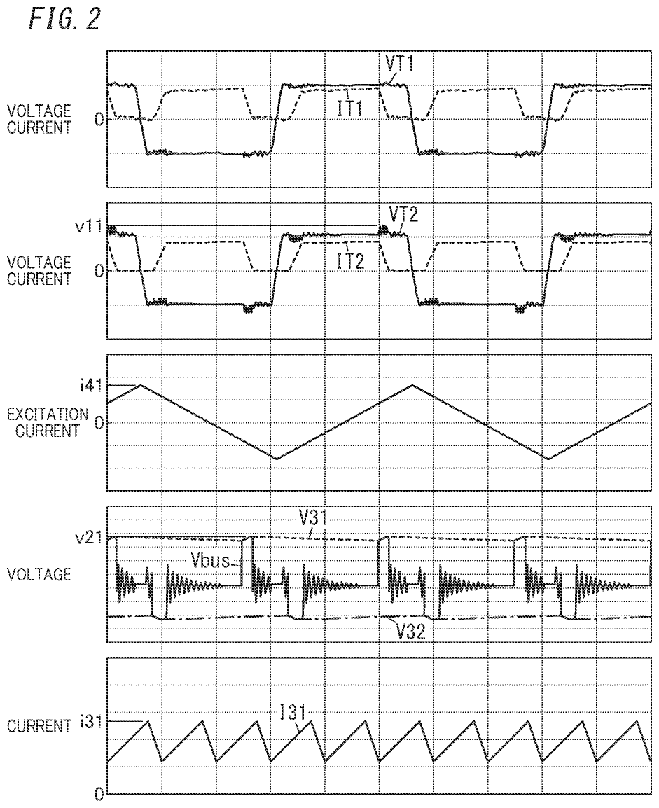

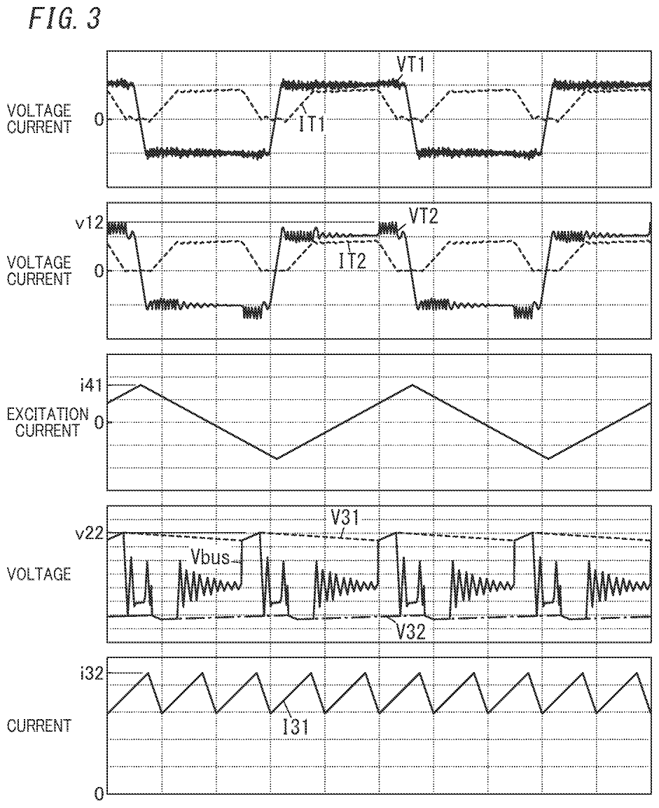

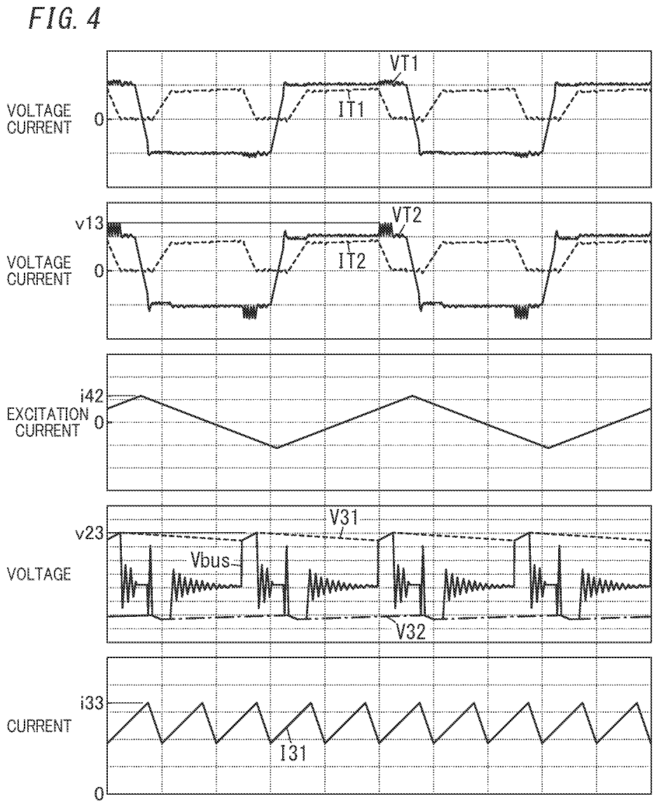

FIG. 2 shows an operation waveform diagram in the case where the power conversion circuit 2 is in a normal state. Moreover, FIG. 3 shows an operation waveform diagram in the case where the power conversion circuit 2 in an abnormal state, specifically, in the case of an abnormal state where the leakage inductance of the transformer 210 is increased as compared to that in the normal state. Moreover, FIG. 4 shows an operation waveform diagram in the case where the power conversion circuit 2 in another abnormal state, specifically, in the case of an abnormal state where the excitation inductance of the transformer 210 is increased as compared to that in the normal state. In FIGS. 2 to 4, a graph of a voltage VT1 across the primary winding wire 211 of the transformer 210 and an input current IT1 to the primary-side center tap CT1 is shown in the uppermost section, a graph of the voltage VT2 across the secondary winding wire 212 of the transformer 210 and an output current IT2 from the secondary-side center tap CT2 is shown in the second section, a graph of the excitation current of the transformer 210 is shown in the third section, a graph of the bus voltage Vbus between the terminals T31 and T32, and the first clamp voltage V31 and the second clamp voltage V32 at the snubber circuit 3 is shown in the fourth section, and a graph of an internal current I31 flowing through the inductor L31 in the snubber circuit 3 is shown in the fifth section.

As illustrated in FIGS. 2 and 3, in the abnormal state where the leakage inductance of the transformer 210 has increased, ringing of the voltage VT2 across the secondary winding wire 212 of the transformer 210 is increased as compared to that in the normal state. Thus, the peak value of the voltage VT2 across the secondary winding wire 212 of the transformer 210 in the case of the power conversion circuit 2 being normal is v11, whereas the peak value of the voltage VT2 across the secondary winding wire 212 of the transformer 210 in the case of the power conversion circuit 2 being abnormal is v12 which is greater than v11. Increased ringing of the voltage VT2 across the secondary winding wire 212 increases electrical energy extracted from the power conversion circuit 2 by the snubber circuit 3. As a result, when the power conversion circuit 2 is in the abnormal state, the value and the effective value of the voltage across the capacitor C31 (the first clamp voltage V31) in the first clamp circuit 31 of the snubber circuit 3 increase as compared to those in the case where the power conversion circuit 2 is in the normal state. In FIGS. 2 and 3, the peak value of the first clamp voltage V31 in the case of the power conversion circuit 2 being in the normal state is v21, whereas the peak value of the first clamp voltage V31 in the case of the power conversion circuit 2 being in the abnormal state is increased to v22 which is greater than v21. Moreover, when the power conversion circuit 2 is in the abnormal state, electrical energy transmitted from the first clamp circuit 31 to the second clamp circuit 32, that is, the value and the effective value of the internal current I31 that flows through the inductor L31 are increased as compared to those in the case where the power conversion circuit 2 is in the normal state. In FIGS. 2 and 3, the peak value of the internal current I31 in the case of the power conversion circuit 2 being in the normal state is i31, whereas the peak value of the internal current I31 in the case of the power conversion circuit 2 being in the abnormal state is increased to i32 which is greater than i31.

Moreover, as illustrated in FIGS. 2 and 4, the excitation current is smaller in the abnormal state where the excitation inductance of the transformer 210 is increased than in the normal state. In FIGS. 2 and 4, the peak value of the excitation current in the case of the power conversion circuit 2 being in the normal state is i41, whereas the peak value of the excitation current in the case of the power conversion circuit 2 being in the abnormal state is reduced to i42 which is less than i41. In the first conversion circuit 21, resonance of the leakage inductance and the excitation inductance of the transformer 210 with the parasitic capacitance achieves soft switching of the switching elements Q11 to Q14. However, if an increase in excitation inductance (a decrease in excitation current) changes a resonance frequency, the soft switching is not achieved, and switching operation of the switching elements Q11 to Q14 results in hard switching. Thus, the peak value of the voltage VT2 across the secondary winding wire 212 of the transformer 210 in the case of the power conversion circuit 2 being normal is v11, whereas the peak value of the voltage VT2 across the secondary winding wire 212 of the transformer 210 in the case of the power conversion circuit 2 being abnormal is v13 which is greater than v11. Increased ringing of the voltage VT2 across the secondary winding wire 212 increases electrical energy extracted from the power conversion circuit 2 by the snubber circuit 3. As a result, when the power conversion circuit 2 is in the abnormal state, the value and the effective value of the voltage across the capacitor C31 (the first clamp voltage V31) in the first clamp circuit 31 of the snubber circuit 3 increase as compared to those in the case where the power conversion circuit 2 is in the normal state. In FIGS. 2 and 4, the peak value of the first clamp voltage V31 in the case of the power conversion circuit 2 being in the normal state is v21, whereas the peak value of the first clamp voltage V31 in the case of the power conversion circuit 2 being in the abnormal state is increased to v23 which is greater than v21. Moreover, when the power conversion circuit 2 is in the abnormal state, electrical energy transmitted from the first clamp circuit 31 to the second clamp circuit 32, that is, the value and the effective value of the internal current I31 that flows through the inductor L31 are increased as compared to those in the case where the power conversion circuit 2 is in the normal state. In FIGS. 2 and 4, the peak value of the internal current I31 in the case of the power conversion circuit 2 being in the normal state is i31, whereas the peak value of the internal current I31 in the case of the power conversion circuit 2 being in the abnormal state is increased to i33 which is greater than i31.

Thus, when the power conversion circuit 2 is in the abnormal state, the voltage of the terminal of the transformer 210, that is, the voltage VT2 across the secondary winding wire 212, the bus voltage Vbus are increased as compared to those the case where the power conversion circuit 2 is in the normal state. As the bus voltage Vbus increases, electrical energy extracted and regenerated by the snubber circuit 3 increases. As a result, the voltage and a current generated at the snubber circuit 3 increase. Examples of the voltage generated at the snubber circuit 3 include the voltage across the capacitor C31 (the first clamp voltage V31) and the voltage across the capacitor C32 (the second clamp voltage V32). Examples of the current generated at the snubber circuit 3 include the internal current I31 flowing through the inductor L31, an input current flowing through the diode D31, an output current flowing through the diode D32.

In the present embodiment, the diagnosis unit 5 makes diagnosis for the power conversion circuit 2 in accordance with main information which is at least one of the voltage of the terminal of the transformer 210, the voltage generated at the snubber circuit 3, or the current generated at the snubber circuit 3. The diagnosis unit 5 makes the diagnosis for the power conversion circuit 2 in accordance with auxiliary information in addition to the main information.

The main information includes information on at least any one of the voltage of the terminal of the transformer 210, the voltage generated at the snubber circuit 3, or the current generated at the snubber circuit 3. Examples of the voltage of the terminal of the transformer 210 include, for example, a voltage VT2 across the secondary winding wire 212 of the transformer 210, a voltage across the winding wire L13, and a voltage across the winding wire L14. Examples of the voltage generated at the snubber circuit 3 include the voltage across the capacitor C31 (the first clamp voltage V31) and the voltage across the capacitor C32 (the second clamp voltage V32). Examples of the current generated at the snubber circuit 3 include the internal current I31 flowing through the inductor L31, an input current flowing through the diode D31, an output current flowing through the diode D32. In the present embodiment, the diagnosis unit 5 uses, as the main information, the current generated at the snubber circuit 3, specifically, the internal current I31 flowing through the inductor L31. The diagnosis unit 5 obtains, as the main information, a sensing result of the internal current I31 from a current detector provided in the power conversion circuit 2.

The auxiliary information includes information on at least any one of input power, output power, or a temperature of the power conversion circuit 2. The input power of the power conversion circuit 2 includes not only an input power value or an input power amount input from the storage battery 6 to the power conversion circuit 2 but also an input voltage Vi which is the voltage across the storage battery 6 and an input current Ii supplied from the storage battery 6 to the power conversion circuit 2. The output power of the power conversion circuit 2 includes not only an output power value or an output power amount output from the power conversion circuit 2 to the power system 7 but also an output voltage Vo and an output current Io. The output voltage Vo may be a voltage between any two terminals of the three alternating current terminals T21, T22, and T23, may be voltages between the terminals, may be an average value of voltages between the terminals, or the like. The output current Io may be a current flowing through any one terminal of the three alternating current terminals T21, T22, and T23, may be currents flowing through the terminals, may be an average value of the currents flowing through the terminals, or the like. The temperature of the power conversion circuit 2 is, for example, the temperature of at least any one of the switching elements Q11 to Q14 and Q21 to Q26 or the temperature of the transformer 210. Moreover, the auxiliary information may include the temperature of the snubber circuit 3, specifically, the temperature of at least one of the switching element Q31 or Q32. In the present embodiment, the diagnosis unit 5 uses the output power and the input power, specifically, the output current Io and the input voltage Vi as the pieces of auxiliary information. The diagnosis unit 5 obtains, as the pieces of auxiliary information, sensing results of the output current Io and the input voltage Vi respectively from the current detector and the voltage detector provided in the power conversion circuit 2.

Based on the pieces of auxiliary information thus obtained, the diagnosis unit 5 sets determination ranges (a normal range, an abnormal range, a caution range) for comparison with the value, which is the main information, of the internal current I31 flowing through the inductor L31.

The normal range is a range in which the value of the main information (the internal current I31 flowing through the inductor L31) can be included when the state of the power conversion circuit 2 is the normal state. If the value of the internal current I31 is included in the normal range, the diagnosis unit 5 determines that the power conversion circuit 2 is in the normal state.

The abnormal range is a range which is outside the normal range and in which the value of the main information (the internal current I31 flowing through the inductor L31) can be included when the state of the power conversion circuit 2 is the abnormal state. If the value of the internal current I31 is included in the abnormal range, the diagnosis unit 5 determines that the power conversion circuit 2 is in the abnormal state.

The caution range is a range which is between the normal range and the abnormal range and in which the value of the main information (the internal current I31 flowing through the inductor L31) can be included when the state of the power conversion circuit 2 is a caution state. The caution state is a state where the state of the power conversion circuit 2 is currently not the abnormal state but is a nearly abnormal state which highly possibly transitions to the abnormal state. If the value of the internal current I31 is included in the caution range, the diagnosis unit 5 determines that the power conversion circuit 2 is in the caution state.

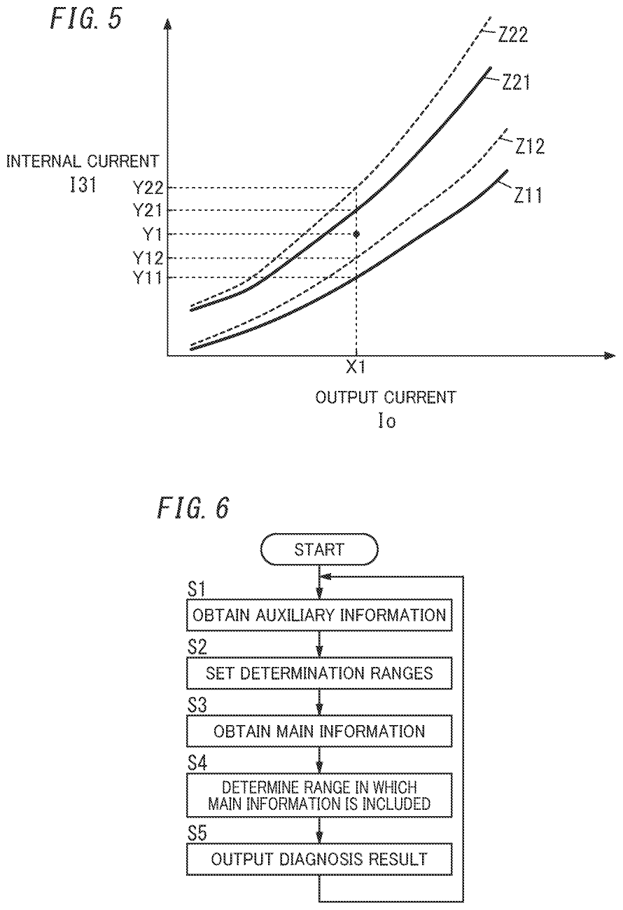

In the present embodiment, the diagnosis unit 5 sets the above-described determination ranges (the normal range, the abnormal range, and the caution range) in accordance with the magnitude of the output current Io and the input voltage Vi, which are the pieces of auxiliary information. FIG. 5 shows a graph of an example of the determination ranges. In FIG. 5, the output current Io is plotted along the abscissa, and the internal current I31 is plotted along the ordinate.

In FIG. 5, Z11 shows an upper limit value of the normal range (a lower limit value of the caution range) in the case of the input voltage Vi having a lower limit value, and Z12 shows a lower limit value of the abnormal range (an upper limit value of the caution range) in the case of the input voltage Vi having a lower limit value. In the case of the input voltage Vi having a lower limit value, the normal rang is a range of less than or equal to the upper limit value Z11 of the normal range, the caution range is a range between the upper limit value Z11 of the normal range and the lower limit value Z12 of the abnormal range, and the abnormal range is a range of greater than or equal to the lower limit value Z12 of the abnormal range. Moreover, Z21 shows an upper limit value of the normal range (a lower limit value of the caution range) in the case of the input voltage Vi having an upper limit value, and Z22 shows a lower limit value of the abnormal range (an upper limit value of the caution range) in the case of the input voltage Vi having an upper limit value. In the case of the input voltage Vi having an upper limit value, the normal rang is a range of less than or equal to the upper limit value Z21 of the normal range, the caution range is a range between the upper limit value Z21 of the normal range and the lower limit value Z22 of the abnormal range, and the abnormal range is a range of greater than or equal to the lower limit value Z22 of the abnormal range.

As illustrated in FIG. 5, the diagnosis unit 5 sets a determination range according to the magnitude of the output current Io and the input voltage Vi. For example, it is assumed that the values represented by the pieces of auxiliary information are the value of the input voltage Vi being the lower limit value and the value of the output current Io being X1. In this case, the diagnosis unit 5 sets a normal range with the upper limit value being Y11. Moreover, the diagnosis unit 5 sets a caution range with the lower limit value being Y11 and the upper limit value being Y12. Moreover, the diagnosis unit 5 sets an abnormal range with the lower limit value being Y12. It is assumed that the value of the internal current I31 represented by the main information is Y1 which is greater than Y12. In this case, the value Y1 of the internal current I31 is included in the abnormal range, the diagnosis unit 5 determines that the power conversion circuit 2 is in the abnormal state.

Moreover, for example, it is assumed that the values represented by the pieces of auxiliary information are the value of the input voltage Vi being the upper limit value and the value of the output current Io being X1. In this case, the diagnosis unit 5 sets a normal range with the upper limit value being Y21. Moreover, the diagnosis unit 5 sets a caution range with the lower limit value being Y21 and the upper limit value being Y22. Moreover, the diagnosis unit 5 sets an abnormal range with the lower limit value being Y22. It is assumed that the value of the internal current I31 represented by the main information is Y1 which is smaller than Y21. In this case, the value Y1 of the internal current I31 is included in the normal range, the diagnosis unit 5 determines that the power conversion circuit 2 is in the normal state.

That is, the diagnosis unit 5 makes diagnosis for the power conversion circuit 2 in consideration of the operating condition of the power conversion circuit 2, and therefore, the diagnosis accuracy can be increased, and the error determination can be reduced.

Moreover, in the present embodiment, the diagnosis unit 5 uses the internal current I31 flowing through the inductor L31 of the snubber circuit 3 as the main information.

As described above, ringing of the voltage VT2 across the secondary winding wire 212 of the transformer 210 increases in the case of an abnormality present in the power conversion circuit 2 as compared to the case of the normal state, thereby, instantaneously increasing the peak value (FIGS. 2 and 4). Thus, when the peak value of the voltage VT2 is used as the value of the main information, the peak value of the voltage VT2 has to be detected by a voltage detector having relatively high time resolution. In contrast, in the case of the internal current I31 being used as the value of the main information, a current peak is repeatedly generated, and therefore, a current detector having a relatively low time resolution may be used, and the peak value of the internal current I31 is more easily measured than that of the voltage VT2. Thus, the accuracy of the diagnosis for the power conversion circuit 2 can be improved.

Moreover, as described above, in the case of an abnormality present in the power conversion circuit 2, the first clamp voltage V31 across the capacitor C31 of the snubber circuit 3 increases (see FIGS. 2 to 4) as compared to the case of the normal state. However, a difference between the first clamp voltage V31 in the case of the power conversion circuit 2 being in the normal state and the first clamp voltage V31 in the case of the power conversion circuit 2 being in the abnormal state is relatively small. Thus, when the peak value of the first clamp voltage V31 is used as the value of the main information, the peak value of the first clamp voltage V31 has to be detected by a voltage detector having relatively high voltage resolution. In contrast, in the case of the internal current I31 being used as the value of the main information, the difference between the internal current I31 in the case of the power conversion circuit 2 being in the normal state and the internal current I31 in the case of the power conversion circuit 2 being in the abnormal state is greater than that of the first clamp voltage V31. Thus, a determination process of determining in which of the normal range, the abnormal range, and the caution range the value of the internal current I31 is included becomes easy, and thus, the accuracy of the diagnosis for the power conversion circuit 2 can be improved.

The power conversion system 1 of the present embodiment further includes an outputter 51.

The outputter 51 is configured to output a diagnosis result of the diagnosis made by the diagnosis unit 5. The outputter 51 is, for example, a communication interface and is configured to communication with the server 8 based on an appropriate communication scheme of wired communication or wireless communication. In the present embodiment, the outputter 51 is configured to communicate with the server 8 via a public network 80 such as the Internet.

The outputter 51 receives a diagnosis result from the diagnosis unit 5, and the diagnosis result thus received is output to the server 8 (an external system). In other words, the diagnosis unit 5 outputs the diagnosis result via the outputter 51 to the server 8.

Thus, for example, an administrator of the power conversion system 1 can manage the state of the power conversion circuit 2.

The diagnosis unit 5 (the outputter 51) may regularly output the diagnosis result to the server 8 regardless of the contents of the diagnosis result. Alternatively, the diagnosis unit 5 (the outputter 51) may output, to the server 8, a notification signal, as the diagnosis result, for notification of the state of the power conversion circuit 2 when the power conversion circuit 2 is in the caution state or the abnormal state.

Note that the outputter 51 may output the diagnosis result to an external system (e.g., a server) provided in a facility the same as the power conversion system 1. In this case, the outputter 51 outputs the diagnosis result to the external system via a local network provided in the facility.

(3) Operation Example

(3.1) Operation of Power Conversion Circuit

With reference to FIG. 1, operation of the power conversion circuit 2 will be briefly described below.

In the present embodiment, the power conversion circuit 2 is, as described above, configured to bidirectionally convert electric power between the set of the two primary-side terminals T11 and T12 and the set of three alternating current terminals T21, T22, and T23 via the transformer 210. That is, the power conversion circuit 2 has two operation modes, namely, an “inverter mode” and a “converter mode”. The inverter mode is an operation mode of converting direct current power input to the two direct current terminals T11 and T12 into three-phase alternating current power, which is to be output from the three second connection terminals T21, T22, and T23. The converter mode is an operation mode of converting three phase alternating current power input to the three alternating current terminals T21, T22, and T23 into direct current power, which is to be output from the two direct current terminals T11 and T12.

In other words, the inverter mode is a mode of producing a voltage drop, among the three alternating current terminals T21, T22, and T23, in a direction the same as a direction in which a current flows through the power system 7, that is, a mode of generating a voltage and a current of the same polarity. The converter mode is a mode of producing a voltage drop, among the three alternating current terminals T21, T22, and T23, in a direction different from a direction in which a current flows through the power system 7, that is, a mode of generating a voltage and a current of different polarities.

In this embodiment, an example will be described in which the operation mode of the power conversion circuit 2 is the inverter mode, and the power conversion circuit 2 converts direct current power into three-phase alternating current power having a frequency of 50 Hz or 60 Hz. For example, the drive frequency of each of the switching elements Q11 to Q14 is 20 kHz.

The control circuit 4 controls the switching elements Q11 and Q12 such that positive and negative voltages are alternately applied to the primary winding wire 211. Moreover, the control circuit 4 controls the switching elements Q13 and Q14 such that the voltage of the terminal T31 with respect to the terminal T32 is positive.

Specifically, the control circuit 4 turns off the switching elements Q12 and Q14 when the switching elements Q11 and Q13 are on, and the control circuit 4 turns on the switching elements Q12 and Q14 when the switching elements Q11 and Q13 are off. In this embodiment, the control circuit 4 controls the switching elements Q11 to Q14 at the same duty ratio. In the present embodiment, the duty ratio of each of the switching elements Q11 to Q14 is “0.5” (substantially 50%).

In this embodiment, the control circuit 4 controls the switching elements Q11 and Q12 such that a high-frequency alternating current voltage is supplied to the primary winding wire 211 and the secondary winding wire 212, and the control circuit 4 controls the switching elements Q13 and Q14 such that a voltage having a positive polarity is supplied to the terminals T31 and T32.

Moreover, the control circuit 4 controls the amplitude of at least one of the voltage or the current output from the alternating current terminals T21, T22, and T23 by turning on or off each of the switching elements Q21 to Q26.

In this embodiment, the control circuit 4 controls the second conversion circuit 22 such that electric power is not transmitted between the first conversion circuit 21 and the second conversion circuit 22 during a first time period including a reverse time period in which the polarity of a voltage applied to the primary winding wire 211 reverses. Moreover, the control circuit 4 controls the second conversion circuit 22 such that during a second time period different from the first time period, electric power is transmitted in a first direction from the first conversion circuit 21 toward the second conversion circuit 22 or a second direction opposite to the first direction.

Specifically, the control circuit 4 operates to repeat the first to fourth modes described below.

In the first mode, the control circuit 4 outputs the drive signals S11 to S14 such that the switching elements Q11 and Q13 are turned on and the switching elements Q12 and Q14 are turned off. Thus, a voltage across the winding wire L11 of the primary winding wire 211 is “+Vi”. Moreover, a voltage across the winding wire L13 of the secondary winding wire 212 is thus “+Vi”. At this time, the switching element Q13 is on, and thus, the bus voltage Vbus between the terminals T31 and T32 is “+Vi”.

In the second mode, the control circuit 4 outputs drive signals S21 to S26 such that the switching elements Q22, Q24, and Q26 on the low-potential side are turned off and the switching elements Q21, Q23, and Q25 on the high-potential-side are turned on. This achieves a circulation mode in which a current circulates in the second converter circuit 22. At this time, all of the switching elements Q11 to Q14 of the first converter circuit 21 are OFF.

In the third mode, the control circuit 4 outputs the drive signals S11 to S14 such that the switching elements Q12 and Q14 are turned on and the switching elements Q11 and Q13 are turned off. Thus, a voltage across the winding wire L12 of the primary winding wire 211 is “−Vi”. Moreover, a voltage across the winding wire L14 of the secondary winding wire 212 is thus “−Vi”. At this time, the switching element Q14 is on, and therefore, the bus voltage Vbus between the terminals T31 and T32 is “+Vi”.

In the fourth mode, the control circuit 4 outputs drive signals S21 to S26 such that the switching elements Q21, Q23, and Q25 on the high potential side are turned off and the switching elements Q22, Q24, and Q26 on the low-potential-side is turned on. This achieves a circulation mode in which a current circulates in the second converter circuit 22. At this time, all of the switching elements Q11 to Q14 of the first converter circuit 21 are OFF.

The control circuit 4 repeats operation in the first mode, the second mode, the third mode, and the fourth mode operation in this order. Thus, the power conversion circuit 2 converts the direct current power from the storage battery 6 into the three-phase alternating current power, which is to be output from the three alternating current terminals T21, T22, and T23 to the power system 7.

(3.2) Operation of Snubber Circuit

With reference to FIG. 1, operation of the snubber circuit 3 will be briefly described below.

When positive ringing occurs in the bus voltage Vbus, the snubber circuit 3 extracts electrical energy of the power conversion circuit 2 by the first clamp circuit 31 to clamp the bus voltage Vbus to the first clamp value (see FIG. 2). In the first clamp circuit 31, the magnitude of the voltage across the capacitor C31 (the first clamp voltage V31) is a first clamp value.

That is, when the positive ringing occurring in the bus voltage Vbus results in the magnitude of the bus voltage Vbus exceeding the first clamp value, the diode D31 is turned on, and the first clamp circuit 31 operates. At this time, as the first clamp circuit 31 extracts the electrical energy, the current having a pulse shape flows through the diode D31. This enables the snubber circuit 3, when the magnitude of the bus voltage Vbus exceeds the first clamp value, to extract electrical energy corresponding to the electrical energy exceeding the first clamp value from the power conversion circuit 2 and to accumulate the electrical energy in the capacitor C31. Thus, even when the positive ringing occurs in the bus voltage Vbus, the maximum value of the bus voltage Vbus is suppressed to the first clamp value.

Moreover, the snubber circuit 3 performs voltage conversion between the first clamp voltage V31 and the second clamp voltage V32 by using the voltage conversion circuit 33 electrically connected between the first clamp circuit 31 and the second clamp circuit 32. The voltage conversion circuit 33 alternately turns on the switching elements Q31 and Q32 based on the drive signals S31 and S32 from the control circuit 4 to step-down the first clamp voltage V31, thereby generating the second clamp voltage V32. Thus, the value (second clamp value) of the voltage across the capacitor C32 as the second clamp voltage V32 is smaller than the value (first clamp value) of the voltage across the capacitor C31 as the first clamp voltage V31. In sum, when the first clamp circuit 31 operates and accumulates electrical energy in the capacitor C31, at least part of the electrical energy is sent via the voltage conversion circuit 33 to the capacitor C32 of the second clamp circuit 32 and is accumulated in the capacitor C32

Moreover, when negative ringing occurs in the bus voltage Vbus, the snubber circuit 3 injects (regenerates) electrical energy into the power conversion circuit 2 by using the second clamp circuit 32 to clamp the bus voltage Vbus to the second clamp value (see FIG. 2). In the second clamp circuit 32, the magnitude of the voltage across the capacitor C32 (the second clamp voltage V32) is a second clamp value.

That is, when the negative ringing occurring in the bus voltage Vbus results in the magnitude of the bus voltage Vbus below the second clamp value, the diode D32 is turned on, and the second clamp circuit 32 operates. At this time, as the electrical energy is injected (regenerated) by the second clamp circuit 32, the current having a pulse shape flows through the diode D32. Therefore, when the magnitude of the bus voltage Vbus falls below the second clamp value, the snubber circuit 3 enables electrical energy corresponding to a current falling below the second clamp value to be regenerated from the capacitor C32 to the power conversion circuit 2. Thus, even when the negative ringing occurs in the bus voltage Vbus, the minimum value of the bus voltage Vbus is suppressed to the second clamp value.

In this embodiment, the electrical energy accumulated in the capacitor C32 is electrical energy sent via the voltage conversion circuit 33 from the capacitor C31 as described above. That is, the snubber circuit 3 regenerates electrical energy extracted from the power conversion circuit 2 by the first clamp circuit 31 at the occurrence of the positive ringing in the bus voltage Vbus from the second clamp circuit 32 to the power conversion circuit 2 at the occurrence of the negative ringing in the bus voltage Vbus. In still other words, in the snubber circuit 3, the electrical energy extracted at the occurrence of the positive ringing is stored once and regenerates the electrical energy at the occurrence of the negative ringing. In this way, the electrical energy of the positive ringing which occurs in the bus voltage Vbus and the electrical energy of the negative ringing are canceled out each other, thereby reducing both the positive ringing and the negative ringing in the bus voltage Vbus. Moreover, regenerating the electrical energy, which has been extracted by the snubber circuit 3, enables the electric power loss of the power conversion system 1 to be reduced.

(3.3) Operation of Diagnosis Unit

Operation of the diagnosis unit 5 will be described with reference to FIG. 6.

First of all, the diagnosis unit 5 obtains auxiliary information (S1). In the present embodiment, the diagnosis unit 5 obtains, as pieces of auxiliary information, sensing results of the output current Io and the input voltage Vi respectively from the current detector and the voltage detector provided in the power conversion circuit 2.

The diagnosis unit 5 sets the determination ranges (see FIG. 5) in accordance with the pieces of auxiliary information thus obtained (S2). In the present embodiment, the diagnosis unit 5 sets the determination ranges (the normal range, the abnormal range, and the caution range) for comparison with the value of the main information in accordance with the magnitude of the output current Io and the input voltage Vi, which are the pieces of auxiliary information.

The diagnosis unit 5 obtains main information (S3). Specifically, the diagnosis unit 5 obtains, as the main information, a sensing result of the internal current I31 flowing through the inductor L31 of the snubber circuit 3 from a current detector provided in the power conversion circuit 2.

Then, the diagnosis unit 5 performs a range determination of determining which of the normal range, the abnormal range, and the caution range includes the value of the main information thus acquired, that is, the value of the internal current I31 (S4). If the value of the main information (the value of the internal current I31) is included in the normal range, the diagnosis unit 5 determines that the power conversion circuit 2 is in the normal state. If the value of the main information (the value of the internal current I31) is included in the abnormal range, the diagnosis unit 5 determines that the power conversion circuit 2 is in the abnormal state. If the value of the main information (the value of the internal current I31) is included in the caution range, the diagnosis unit 5 determines that the power conversion circuit 2 is in the caution state.

The diagnosis unit 5 outputs the diagnosis result via the outputter 51 to the server 8. The server 8 can manage, based on the diagnosis result thus received, the state of the power conversion circuit 2 in the power conversion system 1. Thus, for example, when the server 8 receives the diagnosis result that the power conversion circuit 2 is in the caution state, an administrator of the power conversion system 1 can make repair and the like of the power conversion circuit 2 before the power conversion circuit 2 transitions to the abnormal state. For example, if the power conversion circuit 2 which is in the abnormal state continues to be used, hard switching of or overvoltage application to the switching elements Q11 to Q14, an increase in electrical energy extracted by the first clamp circuit 31 of the snubber circuit 3, or the like may damage circuit elements other than the transformer 210. In the power conversion system 1 of the present embodiment, repair can be made when the power conversion circuit 2 is in the caution state which is a state before transition to the abnormal state. Thus, if the abnormality in the power conversion circuit 2 is caused by the abnormality of the transformer 210, simply replacing the transformer 210 may address the abnormality, thereby suppressing the circuit elements other than the transformer 210 from being damaged.

The diagnosis unit 5 repeatedly performs the above-described processes S1 to S4. For example, the diagnosis unit 5 performs the above-described processes S1 to S4 at a predetermined cycle (e.g., a 10-minute cycle, a 1-hour cycle, or a 1-day cycle).

Note that the diagnosis unit 5 may output the value of the main information to the server 8 (S5) in addition to the diagnosis result. Thus, transition of a change in value of the main information can be grasped, and failure prediction of the power conversion circuit 2 can be made.

(4) Variation

The embodiment described above is merely an example of various embodiments of the present disclosure. Rather, the exemplary embodiment may be readily modified in various manners depending on a design choice or any other factor without departing from the scope of the present disclosure.

In the above example, the internal current I31 flowing through the inductor L31 of the snubber circuit 3 is used as the main information, but the main information is not limited to this example. The main information includes at least one of the voltage of the terminal of the transformer 210, the voltage generated at the snubber circuit 3, or the current generated at the snubber circuit 3. Thus, the main information may be, for example, the voltage VT2 across the secondary winding wire 212 of the transformer 210 or may be a voltage (the bus voltage Vbus) across the winding wire L13, L14. Moreover, examples of the main information include the voltage across the capacitor C31 (the first clamp voltage V31), a voltage across the capacitor C32 (the second clamp voltage V32), an input current flowing through the diode D31, and an output current flowing through the diode D32. The diagnosis unit 5 may make diagnosis for the power conversion circuit 2 in accordance with the plurality of pieces of main information.

Moreover, the example described above adopts the output current Io and the input voltage Vi of the power conversion circuit 2 as the plurality of auxiliary information, but the auxiliary information is not limited to this example. The auxiliary information may include information which is at least any one of input power, output power, or a temperature of the power conversion circuit 2. Thus, the auxiliary information may include, for example, the input current Ii, the output voltage Vo of the power conversion circuit 2, pieces of noise information on the input power and output power of the power conversion circuit 2, and the like. Moreover, the auxiliary information may include the temperature of the power conversion circuit 2. In this case, for example, the diagnosis unit 5 may modify the determination ranges (the normal range, the abnormal range, the caution range) in accordance with the temperature of the power conversion circuit 2. Thus, the accuracy of the diagnosis for the power conversion circuit 2 can be improved.

Moreover, the normal range may be changeable. In this case, the power conversion system 1 preferably includes a setting unit 52 (see FIG. 1) configured to set the normal range. For example, the setting unit 52 may set (modify) the normal range in accordance with different information other than the auxiliary information. The different information is, for example, an accumulated operation time of the power conversion circuit 2. The setting unit 52 further modifies, based on the different information (the accumulated operation time), the determination ranges, which have been set in accordance with the auxiliary information. For example, the setting unit 52 modifies the normal range such that the normal range extends as the accumulated operation time increases. Thus, diagnosis in consideration of the age deterioration of the power conversion circuit 2 can be made, and thus, the accuracy of the diagnosis for the power conversion circuit 2 can be improved. Moreover, the setting unit 52 may be configured to set the determination ranges (the normal range, the abnormal range, the caution range) in accordance with setting information as the different information from the server 8. Note that the setting unit 52 is not limited to have a configuration in which the setting unit 52 is provided in the same housing as the diagnosis unit 5 but the setting unit 52 may be provided in another housing. In this case, the setting unit 52 may be configured to communicate with the diagnosis unit 5 via a network (the public network 80 or a local network) and set the determination ranges (the normal range, the abnormal range, the caution range) in the diagnosis unit 5 from a remote location.

Moreover, in the example described above, the snubber circuit 3 is constituted by a regenerative snubber circuit configured to once store electrical energy extracted when positive ringing occurs in the bus voltage Vbus of the power conversion circuit 2 and regenerate the electrical energy when negative ringing occurs, but the snubber circuit 3 is not limited to this example. For example, the snubber circuit 3 may be an RDC snubber circuit including: a series circuit of a capacitor and a diode electrically connected between the terminals T31 and T32; and a resistor electrically connected in parallel to the diode.

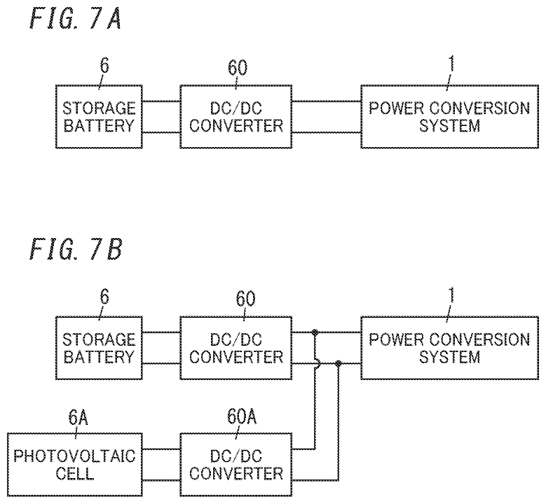

Moreover, as illustrated in FIG. 7A, the power conversion system 1 may be electrically connected to the storage battery 6 via the DC/DC converter 60. The DC/DC converter 60 steps up or steps down a direct current voltage output from the storage battery 6 and outputs the direct current voltage to the power conversion system 1. The power conversion system 1 converts the direct current voltage from the DC/DC converter 60 into a three-phase alternating current voltage and outputs the three-phase alternating current voltage to the power system 7 (see FIG. 1). Moreover, the DC/DC converter 60 is a bidirectional conversion circuit and steps up or steps down a direct current voltage from the power conversion system 1 and outputs the direct current voltage to the storage battery 6.

As illustrated in FIG. 7B, a photovoltaic cell 6A may further be electrically connected via a DC/DC converter 60A to a direct current bus between the DC/DC converter 60 and the power conversion system 1. The DC/DC converter 60A steps up or steps down a direct current voltage output from the photovoltaic battery 6A and outputs the direct current voltage to the power conversion system 1.

Moreover, the power conversion circuit 2 described above is configured to output the three-phase alternating current power to the power system 7 but may be configured to output single-phase alternating current power.

A function similar to the diagnosis unit 5 may be realized by a diagnosis method for the power conversion circuit 2, a computer program, a non-transitory storage medium in which a program is recorded, or the like. A diagnosis method for the power conversion circuit 2 according to an aspect is a diagnosis method for the power conversion circuit 2 which includes the transformer 210 and the switching element configured to be electrically connected to the transformer 210 and which is configured to convert electric power, and the diagnosis method includes a diagnosis process. The diagnosis process includes making diagnosis for the power conversion circuit 2 in accordance with at least one of the voltage of the terminal of the transformer 210, the voltage generated at the snubber circuit 3, or the current generated at the snubber circuit 3, the snubber circuit 3 being configured to be electrically connected to the transformer 210 and being configured to extract electrical energy from the power conversion circuit 2.

A (computer) program according to an aspect is a program configured to cause a computer system to execute the diagnosis method for the power conversion circuit 2.

The power conversion system 1 according to the present disclosure includes a computer system. The computer system includes a processor and a memory as principal hardware components. Some functions of the power conversion system 1 according to the present disclosure may be implemented by making the processor execute a program stored in the memory of the computer system. The program may be stored in the memory of the computer system in advance, provided via telecommunications network, or provided as a non-transitory recording medium such as a computer system-readable memory card, optical disc, or hard disk drive storing the program. The processor of the computer system may be made up of a single or a plurality of electronic circuits including a semiconductor integrated circuit (IC) or a largescale integrated circuit (LSI). The integrated circuit such as IC or LSI mentioned herein may be referred to in another way, depending on the degree of the integration and includes integrated circuits called system LSI, very-large-scale integration (VLSI), or ultra-large-scale integration (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. The plurality of electronic circuits may be collected on one chip or may be distributed on a plurality of chips. The plurality of chips may be collected in one device or may be distributed in a plurality of devices. As mentioned herein, the computer system includes a microcontroller including one or more processors and one or more memories. Thus, the microcontroller is also composed of one or more electronic circuits including a semiconductor integrated circuit or a large-scale integrated circuit.

Moreover, collecting the plurality of functions of the power conversion system 1 in one housing is not an essential configuration of the power conversion system 1. The components of the power conversion system 1 may be distributed in a plurality of housings. Moreover, at least some functions of the power conversion system 1, for example, some functions of the diagnosis unit 5 or the like, may be implemented by cloud (cloud computing) or the like.

### SUMMARY

A power conversion system (1) according to a first aspect includes a power conversion circuit (2), a snubber circuit (3), and a diagnosis unit (5). The power conversion circuit (2) includes a transformer (210) and a switching element (Q11 to Q14) configured to be electrically connected to the transformer (210), and the power conversion circuit (2) is configured to convert electric power. The snubber circuit (3) is electrically connected to the transformer (210) and is configured to extract electrical energy from the power conversion circuit (2). The diagnosis unit (5) is configured to make diagnosis for the power conversion circuit (2) in accordance with at least one of a voltage at a terminal of the transformer (210), a voltage generated at the snubber circuit (3), or a current generated at the snubber circuit (3).

With this aspect, whether or not an abnormality is present in the power conversion circuit (2) is determined.

In a power conversion system (1) of a second aspect referring to the first aspect, the diagnosis unit (5) is configured to make the diagnosis for the power conversion circuit (2) in accordance with main information and auxiliary information. The main information includes information which is at least any one of a voltage at the terminal of the transformer (210, the voltage generated at the snubber circuit (3), or the current generated at the snubber circuit (3). The auxiliary information includes information which is at least any one of input power, output power, or a temperature of the power conversion circuit (2).

With this aspect, the accuracy of the diagnosis for the power conversion circuit (2) is improved.

In a power conversion system (1) of a third aspect referring to the second aspect, the diagnosis unit (5) is configured to determine that the power conversion circuit (2) is in an abnormal state when a value represented by the main information is included in an abnormal range outside a normal range based on the auxiliary information.

With this aspect, the diagnosis for the power conversion circuit (2) is performed in consideration of the operating condition of the power conversion circuit (2).

In a power conversion system (1) of a fourth aspect referring to the third aspect, the diagnosis unit (5) is configured to determine that the power conversion circuit (2) is in a caution state when the value represented by the main information is included in a caution range between the normal range and the abnormal range.

With this aspect, a state before the power conversion circuit (2) transitions to be abnormal is be detected.

In a power conversion system (1) of a fifth aspect referring to the third or fourth aspect, the normal range is changeable.

With this aspect, erroneous diagnosis for the power conversion circuit (2) is reduced.

In a power conversion system (1) of a sixth aspect referring to any one of the first to fifth aspects, the snubber circuit (3) is configured to extract electrical energy from the power conversion circuit (2) and regenerate the electrical energy thus extracted into the power conversion circuit (2). The diagnosis unit (5) is configured to make the diagnosis for the power conversion circuit (2) in accordance with the voltage or the current generated at the snubber circuit (3).

With this aspect, the electric power loss of the power conversion circuit (2) is reduced. Thus, the accuracy of the diagnosis for the power conversion circuit (2) is improved.

A power conversion system (1) of a seventh aspect referring to any one of the first to sixth aspects further includes an outputter (51) configured to output a diagnosis result of the diagnosis unit (5).

With this aspect, the state of the power conversion circuit (2) is managed by an external system.

A diagnosis method for a power conversion circuit (2) of an eighth aspect is a diagnosis method for a power conversion circuit (2) which includes a transformer (210) and a switching element (Q11 to Q14) configured to be electrically connected to the transformer (210) and which is configured to convert electric power, and the diagnosis method includes a diagnosis process. The diagnosis process includes making diagnosis for the power conversion circuit (2) in accordance with at least one of a voltage at a terminal of the transformer (210), a voltage generated by a snubber circuit (3), or a current generated by the snubber circuit (3), the snubber circuit (3) being configured to be electrically connected to the transformer (210) and configured to extract electrical energy from the power conversion circuit (2).

With this aspect, whether or not an abnormality is present in the power conversion circuit (2) is determined.

A program according to a ninth aspect is configured to cause a computer system to execute the diagnosis method for the power conversion circuit (2) of the eighth aspect.

With this aspect, whether or not an abnormality is present in the power conversion circuit (2) is determined.

### REFERENCE SIGNS LIST

1 Power Conversion System
2 Power Conversion Circuit
210 Transformer
3 Snubber Circuit
5 Diagnosis Unit
51 Outputter
Q11 to Q14 Switching Element

1. A power conversion system, comprising:
a power conversion circuit including a transformer and a switching element configured to be electrically connected to the transformer, the power conversion circuit being configured to convert electric power;
a snubber circuit configured to be electrically connected to the transformer and extract electrical energy from the power conversion circuit; and
a diagnosis unit configured to make diagnosis for the power conversion circuit in accordance with at least one of a voltage at a terminal of the transformer, a voltage generated at the snubber circuit, or a current generated at the snubber circuit.

2. The power conversion system of claim 1, wherein
the diagnosis unit is configured to make the diagnosis for the power conversion circuit in accordance with
main information including information which is at least any one of a voltage at the terminal of the transformer, the voltage generated at the snubber circuit, or the current generated at the snubber circuit and
auxiliary information including information which is at least any one of input power, output power, or a temperature of the power conversion circuit.

3. The power conversion system of claim 2, wherein
the diagnosis unit is configured to determine that the power conversion circuit is in an abnormal state when a value represented by the main information is included in an abnormal range outside a normal range based on the auxiliary information.

4. The power conversion system of claim 3, wherein
the diagnosis unit is configured to determine that the power conversion circuit is in a caution state when the value represented by the main information is included in a caution range between the normal range and the abnormal range.

5. The power conversion system of claim 3, wherein
the normal range is changeable.

6. The power conversion system of claim 1, wherein
the snubber circuit is configured to extract electrical energy from the power conversion circuit and regenerate the electrical energy thus extracted into the power conversion circuit, and
the diagnosis unit is configured to make the diagnosis for the power conversion circuit in accordance with the voltage or the current generated at the snubber circuit.

7. The power conversion system of claim 1, further comprising
an outputter configured to output a diagnosis result of the diagnosis unit.

8. A diagnosis method for a power conversion circuit including a transformer and a switching element configured to be electrically connected to the transformer, the power conversion circuit being configured to convert electric power, the method comprising:
making diagnosis for the power conversion circuit in accordance with at least one of a voltage at a terminal of the transformer, a voltage generated at a snubber circuit, or a current generated at the snubber circuit, the snubber circuit being configured to be electrically connected to the transformer and extract electrical energy from the power conversion circuit.

9. A non-transitory storage medium storing a program which is configured to cause a computer system to execute the diagnosis method of claim 8.
